(19) United States
(12) Patent Application Publication
(10) Pub. No.: US 2025/0336024 A1
(43) Pub. Date: Oct. 30, 2025

(54) RESOURCE CONTROL METHOD AND DEVICE

(71) Applicant: Lenovo (Beijing) Limited, Beijing (CN)

(72) Inventors: Zhen WANG, Beijing (CN); Shulai ZHANG, Beijing (CN); Quan CHEN, Beijing (CN); Yan LI, Beijing (CN)

(21) Appl. No.: 19/178,595

(22) Filed: Apr. 14, 2025

(30) Foreign Application Priority Data
Apr. 28, 2024 (CN) 202410524402.5

(51) Int. Cl. G06T 1/20

(52) U.S. Cl. CPC G06T 1/20

(57) ABSTRACT

A resource control method includes intercepting, by an interception module running in a kernel state, a system call request initiated by a process to a kernel driver in an operating system. The system call request includes a process ID of the process and address information of a target graphics memory buffer area that the process requests a GPU to allocate. The method further includes determining, by a configuration management module running in the kernel state and based on the process ID, a target container running the process, obtaining, by the configuration management module, a limited usage of GPU resources configured for the target container to use, and configuring, by a resource management module running in the kernel state and based on the limited usage, an operation permission of the process to the target graphics memory buffer area.

### CROSS-REFERENCE TO RELATED APPLICATION

This application claims priority to Chinese Patent Application No. 202410524402.5, filed on Apr. 28, 2024, the entire content of which is incorporated herein by reference.

### TECHNICAL FIELD

The present disclosure generally relates to the field of computer technologies and, more particularly, to a resource control method and device.

### BACKGROUND

Application scenarios of container virtualization technology are becoming more and more extensive.

When containers are used to run application processes in an electronic device, since multiple processes in different containers may need to request computing resources of a graphics processor at the same time, it is easy to have an unreasonable allocation of the computing resources of the graphics processor.

### SUMMARY

In accordance with the disclosure, there is provided a resource control method including intercepting, by an interception module running in a kernel state, a system call request initiated by a process to a kernel driver in an operating system. The system call request includes a process ID of the process and address information of a target graphics memory buffer area that the process requests a GPU to allocate. The method further includes determining, by a configuration management module running in the kernel state and based on the process ID, a target container running the process, obtaining, by the configuration management module, a limited usage of GPU resources configured for the target container to use, and configuring, by a resource management module running in the kernel state and based on the limited usage, an operation permission of the process to the target graphics memory buffer area.

Also in accordance with the disclosure, there is provided a resource control device including an interception module, a configuration management module, and a resource management module. The interception module is configured to intercept a system call request initiated by a process to a kernel driver in an operating system. The system call request includes a process ID of the process and address information of a target graphics memory buffer area that the process requests a GPU to allocate. The configuration management module is configured to determine a target container running the process based on the process ID, and obtain a limited usage of GPU resources configured for the target container to use. The resource management module is configured to configure an operation permission of the process to the target graphics memory buffer area based on the limited usage.

Also in accordance with the disclosure, there is provided an electronic apparatus including a memory storing a computer program, and a processor configured to execute the computer program to control an interception module running in a kernel state to intercept a system call request initiated by a process to a kernel driver in an operating system. The system call request includes a process ID of the process and address information of a target graphics memory buffer area that the process requests a GPU to allocate. The processor is configured to execute the computer program to control a configuration management module running in the kernel state to determine a target container running the process based on the process ID and to obtain a limited usage of GPU resources configured for the target container to use, and control a resource management module running in the kernel state to configure an operation permission of the process to the target graphics memory buffer area based on the limited usage.

### BRIEF DESCRIPTION OF THE DRAWINGS

To more clearly illustrate the technical solutions of the embodiments of the present disclosure, the drawings needed for use in the description of the embodiments will be briefly introduced below. The drawings described below are some embodiments of the present disclosure. For those of ordinary skill in the art, other drawings can be obtained according to these drawings without any creative work.

FIG. 1 is a flow chart of a resource control method consistent with embodiments of the present disclosure.

FIG. 2 is a schematic diagram showing a principle of obtaining a limited usage of available GPU resources configured for a container by a configuration management module consistent with embodiments of the present disclosure.

FIG. 3 is a flow chart of another resource control method consistent with embodiments of the present disclosure.

FIG. 4 is a schematic diagram showing configuration of operation permissions of a target graphics memory buffer area of a process when available GPU resources of containers are sufficient; consistent with embodiments of the present disclosure.

FIG. 5 is a schematic diagram showing configuration of operation permissions of a target graphics memory buffer area of a process when available GPU resources of containers are insufficient, consistent with embodiments of the present disclosure.

FIG. 6 is a schematic diagram showing adjustment of operation permissions of a target graphics memory buffer area of a process when available GPU resources of containers change from insufficient to sufficient, consistent with embodiments of the present disclosure.

FIG. 7 is a schematic diagram showing an exemplary application consistent with embodiments of the present disclosure.

FIG. 8 is a schematic structural diagram of a resource control device consistent with embodiments of the present disclosure.

FIG. 9 is a schematic structural diagram of an electronic apparatus consistent with embodiments of the present disclosure.

### DETAILED DESCRIPTION OF THE EMBODIMENTS

Embodiments of the present disclosure are described hereinafter with reference to the accompanying drawings. The described embodiments are only some of the embodiments of the present disclosure, and not all of the embodiments. Based on the embodiments in the present disclosure, all other embodiments obtained by those skilled in the art without creative work are within the scope of the present disclosure.

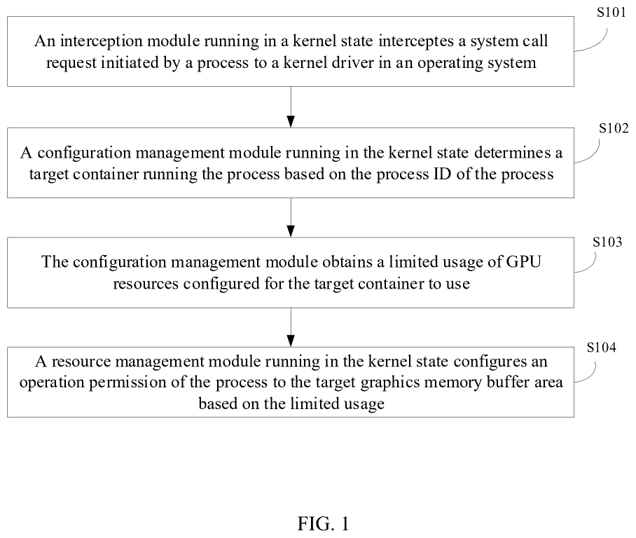

The present disclosure provides a resource control method. In one embodiment, as shown in FIG. 1, which is a flow chart of a resource control method consistent with the present disclosure, the method may be applied to an electronic apparatus, which may be a personal computer, a server, a device node in a distributed system, or a device node in a cluster system, which is not limited here.

In one embodiment, the electronic apparatus may adopt container virtualization technology to run application processes with containers as running carriers. Based on this, at least one container may be deployed in the electronic apparatus, and the at least one container may run one or more processes.

In one embodiment, the method may include S101 to S104.

At S101, an interception module running in a kernel state intercepts a system call request initiated by a process to a kernel driver in an operating system.

The process may run in a container.

It may be understood that, after the process in the container is started, to enable the process to use computing resources of a graphics processing unit (GPU), the process may need to request graphics memory resources from the GPU. The process may write a GPU resource usage request for the use of the GPU computing resources into a graphics memory buffer area allocated by the GPU for the process when subsequent processes need to use the computing resources of the GPU.

The process may request the graphics memory buffer area from the GPU through the kernel driver by initiating the system call request. Based on this, the system call request may be initiated by the process to the kernel driver in the operating system, which is used to request the GPU to allocate the graphics memory buffer area to the process. Correspondingly, the system call request may include: a process ID of the process or address information of the target graphics memory buffer area that the process requests the GPU to allocate.

The process ID of the process may be used to uniquely identify the process. For example, the process ID of the process may be a process identifier (PID) of the process, or a number of the process, etc., which is not limited here. The address information of the target graphics memory buffer area that the process requests the GPU to allocate may be used to identify the target graphics memory buffer area. For example, the address information may be an address range of the target graphics memory buffer area.

The system call request may have multiple possibilities. For example, the process may call the ioctl request of the operating system, and request the graphics memory buffer area from the GPU through the kernel driver by calling the ioctl request.

Since the system call request initiated by the process is initiated to the kernel driver and the kernel driver runs in the kernel state, after the interception module is deployed in the kernel state, the interception module in the kernel state may intercept the system call request initiated by the process to the kernel driver, such that the interception module may intercept the system call request and then confirm the process ID of the process and the address information of the target graphics memory buffer area allocated to the process based on the system call request.

In one optional embodiment, considering that the process initiates the system call request to the kernel driver, the process may write the system call request to a device file corresponding to the kernel driver. Accordingly, the kernel driver may read various requests written to the device file by different processes from the device file. Based on this, the interception module may pre-build a pseudo device file with the same name as the device file of the kernel driver. The process may write the system call request to the pseudo device file. Correspondingly, the interception module may obtain the system call request initiated by the process to the kernel driver from the pseudo device file, thereby intercepting the system call request.

To avoid affecting the process's request for the graphics memory buffer area to the GPU, after the interception module determines the process ID of the process and the address information of the target graphics memory buffer area that the process requests the GPU to allocate, the interception module may forward the system call request to the kernel driver of the operating system, such that the kernel driver may send the system call request to the GPU and the GPU may allocate the target graphics memory buffer area to the process.

The target graphics memory buffer area allocated by the GPU to the process may belong to a part of the graphics memory in the GPU. To enable the process to directly access the target graphics memory buffer area, the GPU may map the address of the target graphics memory buffer area to the address in the user space through address mapping, such that the process is able to directly write the GPU resource usage request to the target graphics memory buffer area. Since the target graphics memory buffer area is used to store relevant commands written by the process, the target graphics memory buffer area of the process may also be called the command buffer of the process.

S102, the configuration management module running in the kernel state determines a target container of the running process based on the process ID of the process.

For example, the configuration management module may query a container ID of the target container to which the process ID belongs from the operating system based on the process ID of the process.

S103, the configuration management module obtains a limited usage of GPU resources configured for the target container to use.

The limited usage of the GPU resources that the target container is able to use may be a maximum usage of the GPU resources allowed to the target container and pre-configured for the target container. For example, the limited usage of the target container may be the maximum usage rate of the GPU allowed to be used by the target container.

In the present embodiment, limited usages of the GPU resources configured by the GPU for different containers may be pre-stored in a configuration management module of the kernel state. Based on the correspondence between the stored different containers and the limited usages, the limited usage of the GPU resources configured for the target container to use may be determined.

S104, the resource management module running in the kernel state configures the process's operation permission for the target graphics memory buffer based on the limited usage.

In one embodiment, the configured process's operation permission for the target graphics memory buffer may include one of allowing write operations or not allowing write operations.

When the process needs to use the computing resources of the GPU, the process may need to write the GPU resource usage request to the target graphics memory buffer area allocated by the GPU for the process. By configuring the process's operation permission for the target graphics memory buffer area, it may be possible to control whether the process is able to write the GPU resource usage request to the target graphics memory buffer area, thereby controlling whether the process is able to request the computing resources of the GPU, and naturally realizing the control of the process's permission to use the computing resources of the GPU.

In the present disclosure, the interception module running in the kernel state may intercept the system call request initiated by the process in the container to the kernel driver of the operating system, and the address information of the target graphics memory buffer area requested by the process in the GPU may be determined. The configuration management module running in the kernel state may determine the limited usage of the GPU resources available to the target container to which the process belongs, such that the resource management module running in the kernel state may reasonably configure the process's operation permission to the target graphics memory buffer area based on the limited usage of the GPU resources that the target container is able to use, thereby realizing a more reasonable control of the use permission of the GPU computing resources of each process in different containers in units of containers.

Further, compared with configuring the available resources of the GPU for each process separately, the present disclosure may configure the limited usage of the GPU resources that are able to be used by each container in units of containers, which may reduce the situation where the process cannot effectively use the GPU resources because of insufficient available resources of the GPU of a single process when the GPU computing resources are sufficient, and may effectively reduce the situation where the GPU computing resources cannot be effectively utilized.

Further, the control of the GPU computing resources for processes in each container in the kernel state may be achieved, avoiding the overhead of frequent switching between the user state and kernel state, and also significantly improving the response speed and efficiency of controlling the use of the GPU computing resources by processes. Moreover, through each program module in the kernel state, it may be possible to control the use permissions of all processes in containers in the electronic apparatus for the GPU computing resources, without the need to improve the hardware on the electronic apparatus, thus having a wider range of applicability.

In the electronic apparatus using virtual containerization technology, the electronic apparatus may run a GPU management module, through which a container may be started. Resource configuration information configured for the container may be obtained during the process of starting the container, and the resource configuration information may be written into a configuration file corresponding to the container. For example, the electronic apparatus may deploy and manage containers using a containerized cluster management system (e.g., a k8s cluster system), in which a GPU Manager may run, and the GPU Manager may start the container and write the resource configuration information into the configuration file of the container.

In the present disclosure, the resource configuration information may include at least the limited usage of the GPU resources that the container is able to use.

When the container is detected to be started, the configuration management module running in the kernel state may create the configuration file in a virtual file system in the kernel state, and map a file path of the created configuration file to a file path corresponding to a file for storing the resource configuration information in the target container.

For example, the configuration management module may confirm the start of the container through the operating system, and the configuration management module may map the created configuration file to the file path of the file used by the container to store the resource configuration information, such that the configuration file created by the configuration management module is mapped to the configuration file used by the container to the store resource configuration information.

After starting the container, the GPU management module may write the resource configuration information into the configuration file of the container, that is, the configuration file created by the configuration management module for the container. Accordingly, the configuration management module may obtain the limited usage of the GPU resources that are able to be used by the container written in the configuration file. Then, the configuration management module may store the correspondence between the limited usage of the GPU resources that are able to be used by the container and the container (such as the container identifier of the container), such that the configuration management module is able to maintain the limited usage of the GPU resources that are able to be used corresponding to all containers started in the electronic device.

It can be understood that after the interception module intercepts the system call request of the process and determines the target container running the process, since the configuration management module may also create the configuration file for the target container when the target container is started and map the path of the configuration file to the file path of the file required to store the resource configuration information of the target container, the configuration management module may also obtain and store the limited usage of the GPU resources corresponding to the target container.

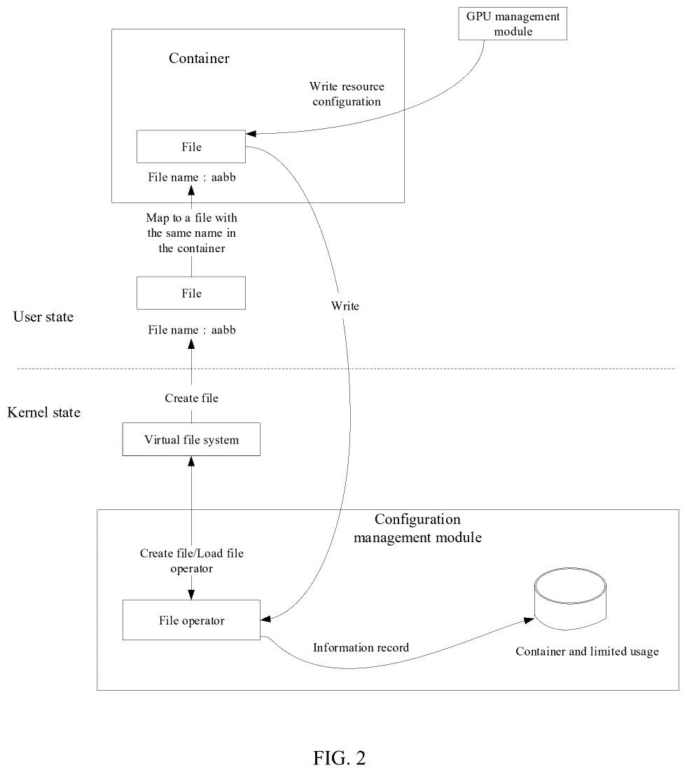

To facilitate understanding of the specific implementation of the configuration management module obtaining and maintaining the limited usage of the GPU resources that are able to be used by each container, an implementation is used as an example to illustrate the present disclosure in following in conjunction with FIG. 2. FIG. 2 is a schematic diagram of the principle of the configuration management module obtaining the limited usage of the available GPU resources configured for the container.

As shown in FIG. 2, after the GPU management module starts the container, the configuration management module may create the configuration file inside the virtual file system in the kernel state, as shown in FIG. 2 where the file name of the configuration file being aabb is used as an example. At the same time, the configuration file may be mapped to a configuration file with the same name in the container. Therefore, the resource configuration information written by the GPU management module to the configuration file of the container may be actually written into the configuration file in the virtual file system.

Since the GPU management module writing the resource configuration information to the configuration file of the container is actually the user writing operation request to the file and the configuration management module confirming the existence of a write operation to the configuration file through the file operator in the operating system, the limited usage of the available GPU resources written in the configuration file may be obtained, and the container identifier of the container may be associated with the limited usage and stored.

It is understandable that, since the process corresponds to the graphics memory buffer area allocated by the GPU for the process in a one-to-one manner, configuring the operation permission of the process for the target graphics memory buffer area corresponding to the process may include configuring the operation permission of the target graphics memory buffer area.

It is understandable that, in practical applications, the current actual usage of the GPU resources by the target container to which the process belongs may affect the use permission of the GPU resources by each process in the target container. Based on this, the resource management module running in the kernel state may also obtain a first actual usage of the GPU resources currently used by the target container. Correspondingly, the resource management module may configure the operation permission of the target graphics memory buffer area based on the first actual usage and the limited usage, where the operation permission includes one of allowing write operations or not allowing write operations.

For example, when the first actual usage of the target container is less than the restricted usage of the GPU resources that the target container is able to use, the resource management module in the kernel state may configure the operation permission of the target graphics memory buffer area to allowing write operations.

When the operation permission of the target buffer area is allowing write operations, the process may write the GPU resource usage request to the target graphics memory buffer area, such that the GPU obtains the GPU resource usage request from the target graphics memory buffer area and processes it to make the process being able to use the GPU computing resources.

On the contrary, when the first actual usage of the target container is not less than the limited usage of the GPU resources that the target container is able to use, the kernel state resource management module may configure the operation permission of the target graphics memory buffer area to not allowing write operations.

When the operation permission of the target graphics memory buffer area is not allowing write operation, the process cannot write the GPU resource usage request to the target graphics memory buffer area. For example, when the operation permission of the target graphics memory buffer area is not allowing write operations, the process may need to initiate a write request to write the GPU resource usage request to the target graphics memory buffer area by calling the target interface of the operating system when the process needs to write the GPU resource usage request to the target graphics memory buffer area. Then, the resource management module may block the call of the target interface, that is, block the write request, such that the process cannot write the GPU resource usage request to the target graphics memory buffer area.

In actual applications, when the target memory buffer area's operation permission is not allowing write operations, to avoid the process frequently initiating write requests to the target memory buffer area or continuously waiting for write requests to be initiated which wastes resources, the resource management module may also control the process to enter a dormant state.

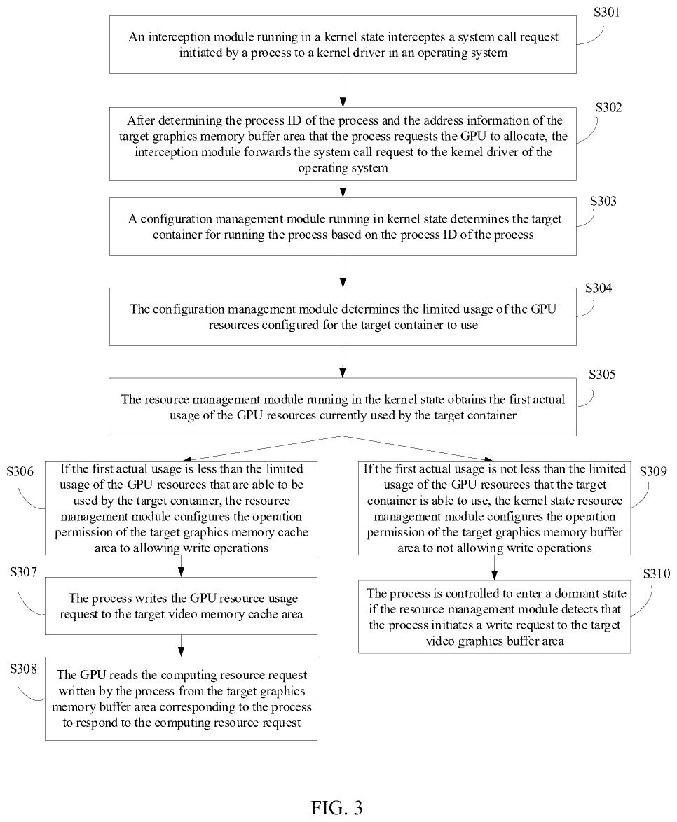

In one embodiment, as shown in FIG. 3, which is a flow chart of another resource control method consistent with the present disclosure, the method may include S301 to S310.

S301, an interception module running in a kernel state intercepts a system call request initiated by a process to a kernel driver.

The system call request may include: the process ID of the process and the address information of the target graphics memory buffer area that the process requests the GPU to allocate.

S302, after determining the process ID of the process and the address information of the target graphics memory buffer area that the process requests the GPU to allocate, the interception module forwards the system call request to the kernel driver of the operating system.

It may be understood that after forwarding the system call request to the kernel driver of the operating system, the kernel driver may forward the system call request to the GPU, and the GPU may allocate the target graphics memory buffer area to the process based on the address information of the target graphics memory buffer area that the process requests the GPU to allocate.

S303, a configuration management module running in the kernel state determines the target container for running the process based on the process ID of the process.

S304, the configuration management module determines the limited usage of the GPU resources configured for the target container to use.

For example, the configuration management module may query the container identifier of the target container to which the process ID of the process belongs from the operating system, and then query the limited usage of the GPU resources corresponding to the container identifier of the target container based on the limited usages of the GPU resources corresponding to container identifiers of the different containers maintained.

S305, the resource management module running in the kernel state obtains the first actual usage of the GPU resources currently used by the target container.

For example, the resource management module may confirm the actual usage of the GPU resources currently used by the target container through the operating system. For the sake of distinction, the actual usage determined here is referred to as the first actual usage.

S306, if the first actual usage is less than the limited usage of the GPU resources that are able to be used by the target container, the resource management module running in the kernel state configures the operation permission of the target graphics memory buffer area to allowing write operations.

The resource management module may determine the limited usage of the GPU resources that are able to be used by the target container through the configuration management module, and compare the limited usage with the first actual usage of the GPU resources currently used by the target container.

There may be multiple specific implementations of the resource management module configuring the operation permission of the target graphics memory buffer area. For example, the operation permission corresponding to the address information of the target graphics memory buffer area may be configured such that the operating system is able to determine the operation permission of the target graphics memory buffer area based on the address information of the target graphics memory buffer area.

It may be understood that, in the present disclosure, there may be no need to restrict the process from reading the target graphics memory buffer area. Therefore, when the operation permission of the target graphics memory buffer area includes allowing write operations or not allowing write operations, the operation permission of the target graphics memory buffer area may include allowing read operations.

S307, if the operation permission of the target graphics memory buffer area is allowing write operations, the process writes the GPU resource usage request to the target graphics memory buffer area.

The process may initiate the write request to the target graphics memory buffer area by calling the target interface of the operating system, and the write request may be used to request to write the GPU resource usage request. The operating system may detect the process's call to the target interface and confirm that the operation permission of the target graphics memory buffer area is allowing write operations. Then, the operating system may allow the process to write the GPU resource usage request to the target graphics memory buffer area.

S308, the GPU reads the computing resource request written by the process from the target graphics memory buffer area corresponding to the process to respond to the computing resource request.

For example, the GPU may periodically read and process the computing resource request from the target graphics memory buffer area of the process. The specific process of the GPU processing the computing resource request is not limited in the present disclosure and will not be described in detail here.

It can be understood that when the operation permission of the target graphics memory buffer area corresponding to the process is allowing write operations, the process may write the GPU resource usage request into the target graphics memory buffer area. Therefore, when the operation permission of the target graphics memory buffer area is allowing write operations, it may mean that the process has the time slice to use the GPU, such that the process is able to apply to the GPU for the use of the GPU computing resources.

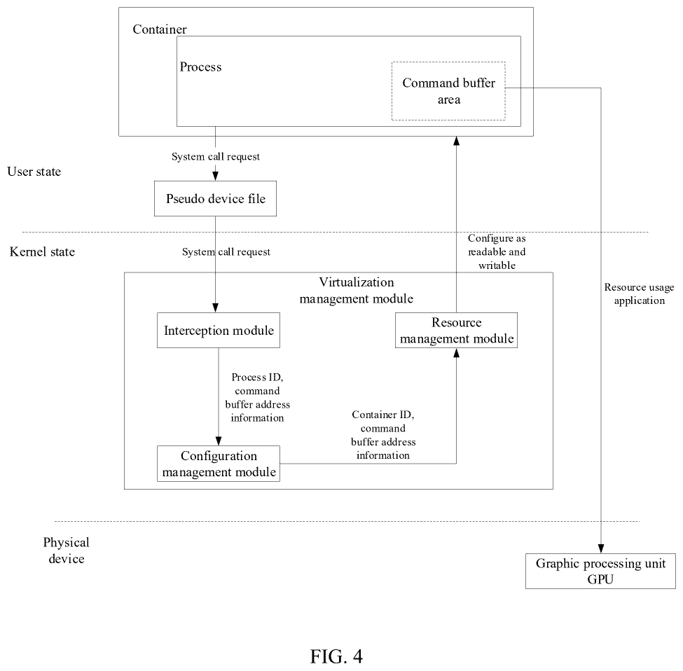

FIG. 4, which is a schematic diagram of configuring the operation permission of the target graphics memory buffer area of the process to be allowing write operations when the GPU resources which are able to be used by the target container are sufficient, is used below as an example to facilitate a more intuitive understanding of the implementation process of configuring the operation permission of the target graphics memory buffer area of the process to be allowing write operation.

As shown in FIG. 4, a virtualization management module is added to the operating system kernel, and the virtualization management module includes an interception module, a configuration management module and a resource management module. Since the virtualization management module is in the operating system kernel, the interception module, the configuration management module and the resource management module all run in the kernel state.

As shown in FIG. 4, the container deployed in the electronic device runs in the user state, and a process may run in the container. After the process in the container is started, the process may call the system call request of the operating system and initiate a request to the GPU to request the graphics memory buffer area through the system call request. For example, the process may write the system call request to the pseudo device file.

Since the system call request is sent from the user state to the kernel driver of the operating system, the interception module in the kernel state may intercept the system call request, for example, the interception module may obtain the system call request written by the process from the pseudo device file deployed in the user state. Of course, the specific implementation of the interception module intercepting the system call request may be referred to the previous related description, which will not be repeated here.

After the interception module intercepts the system call request, it may obtain the process identifier (i.e., process ID) of the process in the system call request and the address information of the graphics memory buffer area (i.e., target graphics memory buffer area) that the process requests the GPU to allocate, and send the process ID and the address information of the graphics memory buffer area to the configuration management module.

The configuration management module may determine the container identifier (i.e., container ID) of the target container to which the process ID belongs, and the configuration management module may send the container ID and the address information of the graphics memory buffer area to the resource configuration module. Since the configuration management module pre-obtains and stores the limited usage of the GPU resources corresponding to different container IDs, the resource management module may obtain the limited usage of the GPU resources corresponding to the container through the configuration management module based on the container ID.

After the configuration management module inquires the operating system about the first actual usage of the GPU resources currently used by the container based on the container ID and determines that the first actual usage is less than the limited usage corresponding to the container, the configuration management module may set the operation permission of the target graphics memory buffer area (command buffer in FIG. 4) corresponding to the process to readable and writable. Correspondingly, the process may write the GPU resource usage request to the command buffer.

It is understandable that the command buffer area allocated by the GPU to the process belongs to the GPU's graphics memory while the address is mapped to the user state address such that the process is able to directly access the command buffer area. Therefore, in FIG. 4 to FIG. 6, the command buffer area is marked with a dotted box in the process.

S309, if the first actual usage is not less than the limited usage of the GPU resources that the target container is able to use, the kernel state resource management module configures the operation permission of the target graphics memory buffer area to not allowing write operations.

S310, if the operation permission of the target graphics memory buffer area is not allowing write operations, the process is controlled to enter a dormant state if the resource management module detects that the process initiates a write request to the target graphics memory buffer area.

The write request may be used to request to write the GPU resource usage request.

It is understandable that, when the operation permission of the target graphics memory buffer area is not allowing write operations, the process may not have a time slice to use the GPU. Therefore, after the operating system detects the write request initiated to the target graphics memory buffer area, the kernel driver of the operating system may block the write request, such that the process cannot write the GPU resource usage request to the target graphics memory buffer area. The process may still cache the GPU resource usage requests that have not been successfully written corresponding to the process into the stack.

There are also multiple possibilities for the specific implementation of the resource management module detecting that the target graphics memory buffer area initiates the write request.

In one possible implementation, when the operation permission of the target graphics memory buffer area is not allowing write operations, if the signal management module running in the target container detects an operation-unauthorized instruction sent by the operating system kernel, it may write a system call instruction to the target device file.

The operation-unauthorized instruction may indicate that the process has initiated the write request to the target graphics memory buffer area when the operation permission of the target graphics memory buffer area is not allowing write operations.

The target device file may be a file used for information exchange between the user state and kernel state. The target device file may be located in the user state.

Accordingly, when the resource management module detects that the system call instruction is written in the target device file, the resource management module may confirm that the process has currently initiated the write request to the target graphics memory buffer area that does not allow write operations. Therefore, to avoid the process from frequently initiating write requests, the resource management module may control the process to enter the dormant state.

Of course, when the resource management module detects the system call indication, the resource management module may also block the system call indication to achieve the purpose of blocking the write request initiated by the process, such that the process may no longer call the target interface for initiating the write request, and naturally may no longer initiate the write request to write the GPU resource usage request to the target graphics memory buffer area.

In the present disclosure, when the operation permission of the target graphics memory buffer area is not allowing write operations, the target graphics memory buffer area may still allow read operations. Therefore, the state of the target graphics memory buffer area not allowing write operations may also be considered as the operation permission is read-only.

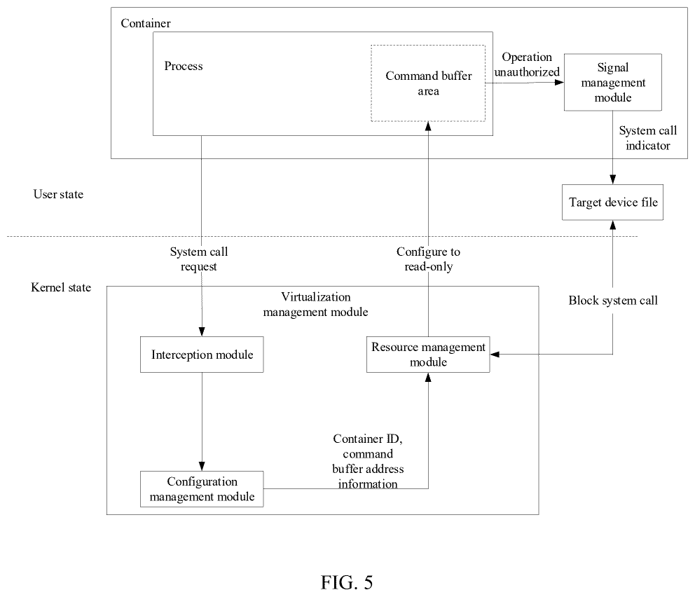

To facilitate understanding of the operation permission of the target graphics memory buffer area of the configuration process is not allowing write operations, and the implementation process of controlling the process to enter the dormant state, FIG. 5 will be used as an example below.

In FIG. 5, a signal management module is also deployed in the container, and the signal management module is configured to generate an operation-unauthorized indication when the process attempts to write a GPU resource usage request to a command buffer in a read-only state.

Also, a target device file is also deployed in the user state of the electronic device, and the target device file is configured to receive the system call indication issued by the signal management module, and enable the resource management module running in the kernel state to obtain the written system call indication through the target device file.

In FIG. 5, for the operation of the interception module and the configuration management module running in the kernel state, references may be made to the relevant description of FIG. 4 above, which will not be repeated here.

In FIG. 5, when the resource management module determines that the actual usage of the GPU of the container to which the process belongs is not less than the limited usage of the container, the resource management module configures the operation permission of the command buffer corresponding to the process as read-only, that is, write operations are not allowed.

When the operation permission of the command buffer corresponding to the process is read-only, if the process initiates a write request to the command buffer by calling the target interface of the operating system kernel, the operating system kernel may trigger a segmentation fault and send the operation-unauthorized indication to the signal management module.

After receiving the operation-unauthorized indication, the signal management module may write the system call indication to the target device file, such as a read system call.

Correspondingly, after the resource management module obtains the system call indication through the target device file, the resource management module may block the system call indication. Therefore, the process may no longer trigger the kernel operation to generate a new write request, and its original unsuccessful write request may still be cached in the process stack. To reduce the power consumption of the process, the resource management module may instruct the process to enter the dormant state such that the process is in a low power consumption state.

It can be understood that when the operation permission of the target graphics memory buffer area is not allowing write operations, the actual usage of GPU computing resources used by other processes in the target container may be constantly changing, such that the actual usage of GPU resources used by the target container at different times is also constantly changing. Therefore, after the resource management module configures the operation permission of the target graphics memory buffer area to not allowing write operations, it may also obtain the second actual usage of the GPU resources currently used by the target container. For example, the second actual usage of the target container may be obtained periodically, etc., which is not limited here.

Correspondingly, when the second actual usage is less than the restricted usage corresponding to the target container, the resource management module may also configure the operation permission of the target graphics memory buffer area to allowing write operations, such that the process is able to write the GPU resource usage request to the target graphics memory buffer area, thereby being able to use the computing resources of the GPU.

Further, when the second actual usage is less than the limited usage, the resource management module may also wake up the process in the dormant state. Therefore, the process may continue to obtain the cached GPU resource usage request from its stack and write it to the target graphics memory buffer area.

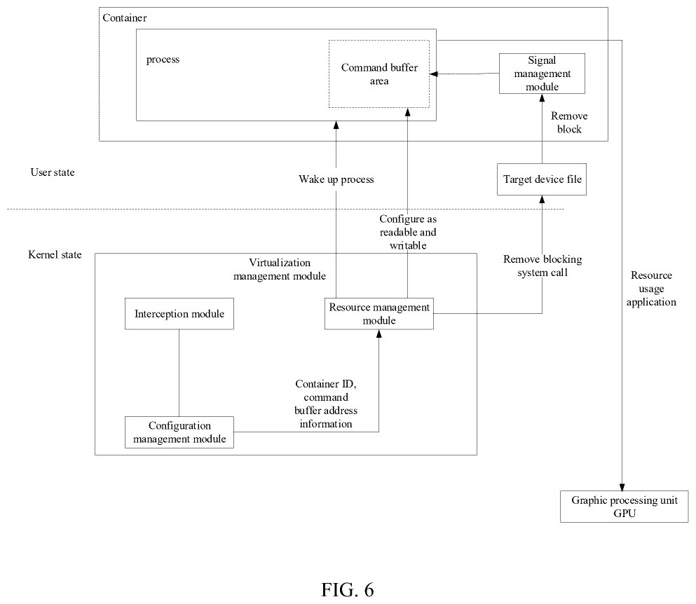

For ease of understanding, FIG. 6 will be used as an example to illustrate the specific implementation of changing the operation permission of the target graphics memory buffer area from not allowing write operations to allowing write operations and the related operations involved. FIG. 6 may be understood as modifying the operation permission of the command buffer corresponding to the process based on FIG. 5.

Based on FIG. 5, when the kernel-state resource management module determines that the actual usage of the GPU used by the container is less than its corresponding restricted usage, the resource management module may adjust the operation permission of the command buffer corresponding to the process to readable and writable, that is, allowing write operations and read operations, such that the process regains the time slice of using the GPU, as shown in FIG. 6.

Further, it can be seen from FIG. 6 that while adjusting the operation permission of the command buffer to readable and writable, the resource management module may also unblock the system call indication in the target device file and wake up the process. Therefore, the process may obtain the GPU resource usage request that has not been successfully written from the stack and continue to write the GPU resource usage request to the command buffer, and the GPU may also read the GPU resource usage request written by the process from the command buffer.

The following is an example of a process initiating four GPU resource usage requests, and the four GPU resource usage requests initiated by the process are respectively referred to as K1, K2, K3 and K4.

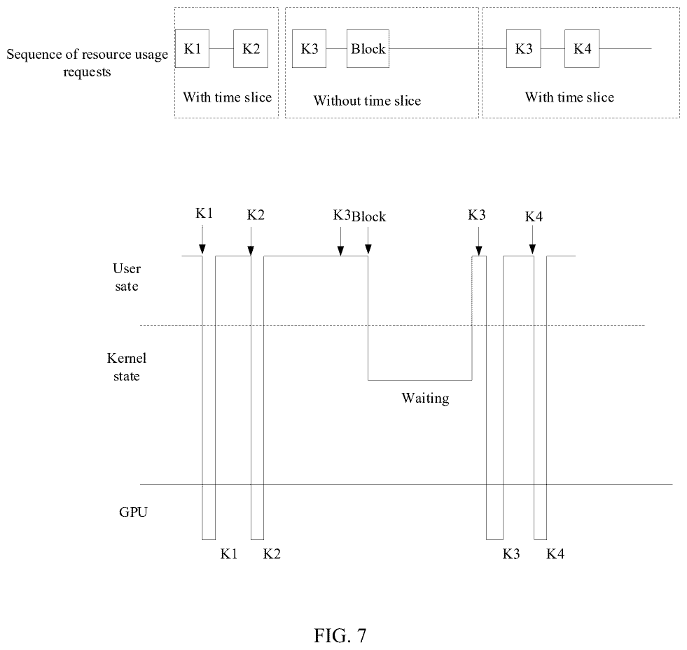

When the operation permission of the target graphics memory buffer corresponding to the process is not allowing write operations, the process may have no time slice for using the GPU; when the operation permission of the target graphics memory buffer is allowing write operations, the process may have a time slice for using the GPU. On this basis, it is explained in conjunction with FIG. 7.

The upper part of FIG. 7 shows the situation of the time slice owned by the process. In FIG. 7, it is assumed that when the process initiates the two GPU resource usage requests K1 and K2, the process has a time slice for using the GPU. When the process initiates the GPU resource usage request K3, the process does not have a time slice for using the GPU, and the system call corresponding to the GPU resource usage request will be blocked until the process has a time slice for using the GPU again.

Combined with the call sequence state diagram at the bottom of FIG. 7, it can be seen that when the user-state process initiates K1, since the process has a time slice, through the solution of the present disclosure, the process is able to write K1 to the target graphics memory buffer area through the kernel state, such that the GPU is able to read K1. The same is true for K2.

After initiating K2, when the process initiates a write request to write K3, since the process does not have a time slice to use the GPU, the system call corresponding to the write request to write K3 may be blocked. At this time, K3 cannot be written to the target graphics memory buffer area, and the GPU naturally cannot read K3.

After the process's write request is blocked for a period of time, when the process regains the time slice to use the GPU, K3 is able to be written to the target graphics memory buffer area, and the GPU is also able to read K3. The corresponding process also needs to continue to write the next GPU resource usage request K4, which will not be repeated.

The present disclosure also provides a resource control device.

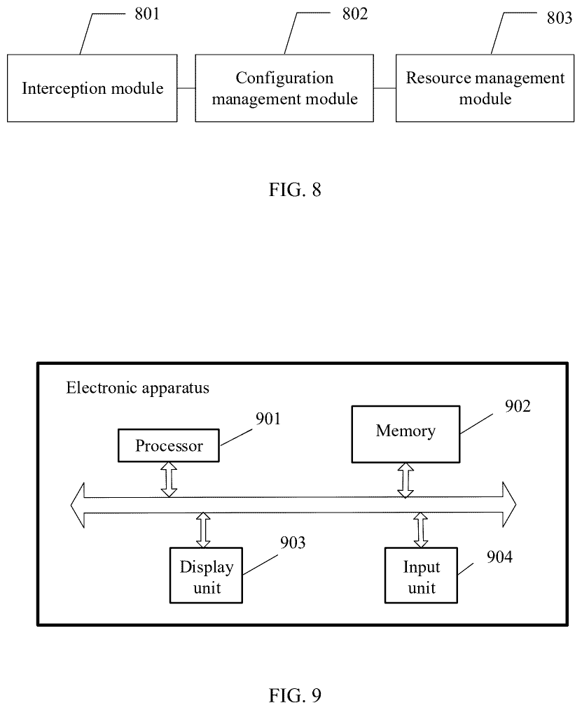

As shown in FIG. 8, which is a schematic structural diagram of a resource control device consistent with the present disclosure, in one embodiment, the device includes: an interception module 801 running in kernel state, a configuration management module 802, and a resource management module 803;

The interception module 801 may be configured to intercept a system call request initiated by a process to a kernel driver in an operating system, where the system call request may include a process ID of the process and address information of a target graphics memory buffer area that the process requests the GPU to allocate.

The configuration management module 802 may be configured to determine a target container running the process based on the process ID of the process.

The configuration management module 802 may also be configured to obtain a limited usage of the GPU resources that the target container is configured to use.

The resource management module 803 may be used to configure the process's operation permissions for the target graphics memory buffer area based on the limited usage.

In one possible embodiment, the resource management module may be further configured to obtain a first actual usage of the GPU resource currently used by the target container.

Correspondingly, when the resource management module configures the operation permission of the process to the target graphics memory buffer area based on the limited usage, the resource management module may be configured to, based on the first actual usage and the limited usage, configure the operation permission of the target graphics memory buffer area, where the operation permission includes one of allowing write operations or not allowing write operations.

In another possible embodiment, the resource management module may be also configured to control the process to enter a dormant state when it is detected that the process initiates a write request to the target graphics memory buffer area when the operation permission of the target graphics memory buffer area is not allowing write operations, where the write request is used to request to write a GPU resource usage request.

In another possible embodiment, the resource control device may further include: a signal management module deployed in the target container. The signal management module may be configured to write a system call indication to the target device file if an operation-unauthorized indication sent by the operating system kernel is detected when the operation permission of the target graphics memory buffer area is not allowing write operations. The operation-unauthorized indication may indicate that when the operation permission of the target graphics memory buffer area is not allowing write operations, the process initiates a write request to the target graphics memory buffer area, where the target device file is a file for information exchange between user state and kernel state.

Correspondingly, when controlling the process to enter the dormant state, the resource management module is specifically used to detect that the system call indication is written in the target device file, and control the process to enter the dormant state.

In another possible embodiment, the resource management module may be also configured to: obtain the second actual usage of the GPU resource currently used by the target container when the operation permission of the target graphics memory buffer area is not allowing write operations, where the operation permission of the target graphics memory buffer area is configured to allowing write operations when the second actual usage is less than the restricted usage.

In another possible embodiment, the resource management module may also be configured to wake up the process in the dormant state when the second actual usage is less than the restricted usage.

In another possible embodiment, the interception module may also be configured to construct a pseudo device file with the same name as the device file of the kernel driver in the operating system;

Correspondingly, when the interception module intercepts the system call request initiated by the process to the kernel driver, it may obtain the system call request initiated by the process to the kernel driver from the pseudo device file.

In another possible embodiment, the interception module may be also configured to forward the system call request to the kernel driver of the operating system after determining the process ID of the process and the address information of the target graphics memory buffer area requested by the process to be allocated by the GPU.

In another possible embodiment, the configuration management module may be also configured to create a configuration file in the virtual file system in the kernel state, map the file path of the configuration file to the file path corresponding to the file for storing resource configuration information in the target container, obtain the limited usage of GPU resources that the target container configured in the configuration file can use, and store the corresponding relationship between the limited usage and the target container, when it is detected that the target container is started.

The present disclosure also provides an electronic apparatus. In one embodiment, as shown in FIG. 9, which is a schematic structural diagram of an electronic apparatus. The electronic apparatus may be any type of electronic apparatus, and the electronic apparatus at least includes a processor 901 and a memory 902.

The processor 901 may be configured to execute the resource control method provided by any embodiments of the present disclosure.

The memory 902 may be configured to store the program required for the processor to perform operations.

It can be understood that the electronic apparatus may further include a display unit 903 and an input unit 904.

Of course, the electronic apparatus may include have more or fewer components than FIG. 9, which is not limited here.

The present disclosure also provides a computer-readable storage medium, in which at least one instruction, at least one program, a code set or an instruction set is stored. The at least one instruction, the at least one program, the code set or instruction set may be loaded and executed by a processor to implement the resource control method provided by any embodiments of the present disclosure.

The present disclosure also proposes a computer program, which includes computer instructions. The computer instructions may be stored in a computer-readable storage medium. When the computer program is run on an electronic apparatus, it may be used to execute the resource control method provided by any embodiments of the present disclosure.

In the present disclosure, the terms such as “first,” “second,” “third,” “fourth,” etc., involved are merely used to distinguish similar objects and do not represent a specific ordering of the objects. It is understandable that “first/second/third” may be interchanged with a specific order or sequence where permitted, such that the embodiments of the present disclosure described herein may be implemented in an order other than that illustrated or described herein.

Each embodiment in the present disclosure is described in a progressive manner, and each embodiment focuses on the differences from other embodiments. The same and similar parts between the embodiments can be referred to each other. The features recorded in each embodiment in the present disclosure can be replaced or combined with each other, such that those skilled in the art can implement or use the present disclosure. For the device embodiments, since they are basically similar to the method embodiments, the description is relatively simple, and the relevant parts can be referred to the corresponding description of the method embodiments.

Finally, it should be noted that in the present disclosure, relational terms such as first or second are only used to distinguish one entity or operation from another entity or operation, and do not necessarily require or imply any such actual relationship or order between these entities or operations. Further, the terms “include,” “comprise” or any other variant thereof are intended to cover non-exclusive inclusion, such that a process, method, article or device including a series of elements includes not only those elements, but also other elements not explicitly listed, or also includes elements inherent to such process, method, article or device. In the absence of further restrictions, the elements defined by the sentence “including one . . . ” do not exclude the existence of other identical elements in the process, method, article or device including the elements.

The above description of the disclosed embodiments enables those skilled in the art to implement or use the present disclosure. Various modifications to these embodiments will be apparent to those skilled in the art, and the general principles defined herein may be implemented in other embodiments without departing from the spirit or scope of the present disclosure. Therefore, the present disclosure is not limited to the embodiments shown herein, but conform to the widest scope consistent with the principles and novel features disclosed herein.

The above are only some embodiments of the present disclosure. It should be noted that for those of ordinary skill in the art, improvements and modifications can be made without departing from the principles of the present disclosure, and these improvements and modifications should also be regarded as being within the scope of the present disclosure.

What is claimed is:

1. A resource control method comprising:
intercepting, by an interception module running in a kernel state, a system call request initiated by a process to a kernel driver in an operating system, the system call request including a process ID of the process and address information of a target graphics memory buffer area that the process requests a GPU to allocate;
determining, by a configuration management module running in the kernel state and based on the process ID, a target container running the process;
obtaining, by the configuration management module, a limited usage of GPU resources configured for the target container to use; and
configuring, by a resource management module running in the kernel state and based on the limited usage, an operation permission of the process to the target graphics memory buffer area.

2. The method according to claim 1, further comprising:
obtaining, by the resource management module, an actual usage of GPU resources currently used by the target container;
wherein configuring the operation permission includes:
configuring the operation permission based on the actual usage and the limited usage, the operation permission including allowing write operations or not allowing write operations.

3. The method according to claim 2, further comprising:
in response to the operation permission being not allowing write operations, controlling the process to enter a dormant state responding to the resource management module detecting that the process initiates a write request to the target graphics memory buffer, the write request being used to request to write a GPU resource usage request.

4. The method according to claim 3, wherein controlling the process to enter the dormant state responding to the resource management module detecting that the process initiates the write request includes:
responding to a signal management module in the target container detects an operation-unauthorized instruction sent by the operating system kernel, writing a system call instruction into a target device file, the operation-unauthorized instruction indicating that the process initiates the write request to the target graphics memory buffer area while the operation permission is not allowing write operations, and the target device file being used for information exchange between a user state and kernel state; and
controlling, by the resource management module, the process to enter the dormant state in response to detecting that the system call instruction is written into the target device file.

5. The method according to claim 2,
wherein the actual usage is a first actual usage;
the method further comprising:
in response to the operation permission being not allowing write operations, obtaining, by the resource management module, a second actual usage of the GPU resources currently used by the target container; and
in response to the second actual usage being less than the limited usage, configuring, by the resource management module, the operation permission to allowing write operations.

6. The method according to claim 5, further comprising:
in response to the second actual usage being less than the limited usage, waking up, by the resource management module, the process in a dormant state.

7. The method according to claim 1, further comprising:
constructing, by the interception module, a pseudo device file with a same name as a device file of the kernel driver in the operating system;
wherein intercepting the system call request includes obtaining the system call request from the pseudo device file.

8. The method according to claim 1, further comprising, after determining the process ID and the address information:
forwarding, by the interception module, the system call request to the kernel driver.

9. The method according to claim 1, further comprising:
in response to detecting that the target container is started, creating, by the configuration management module, a configuration file in a virtual file system in the kernel state, and mapping, by the configuration management module, a file path of the configuration file to a file path corresponding to a file for storing resource configuration information in the target container;
obtaining, by the configuration management module, the limited usage of the GPU resources that are able to be used by the target container configured in the configuration file; and
storing, by the configuration management module, a corresponding relationship between the limited usage and the target container.

10. A resource control device comprising:
an interception module configured to intercept a system call request initiated by a process to a kernel driver in an operating system, the system call request including a process ID of the process and address information of a target graphics memory buffer area that the process requests a GPU to allocate;
a configuration management module configured to:
determine a target container running the process based on the process ID; and
obtain a limited usage of GPU resources configured for the target container to use; and
a resource management module configured to configure an operation permission of the process to the target graphics memory buffer area based on the limited usage.

11. An electronic apparatus comprising:
a memory storing a computer program; and
a processor configured to execute the computer program to:
control an interception module running in a kernel state to intercept a system call request initiated by a process to a kernel driver in an operating system, the system call request including a process ID of the process and address information of a target graphics memory buffer area that the process requests a GPU to allocate;
control a configuration management module running in the kernel state to determine a target container running the process based on the process ID;
control the configuration management module to obtain a limited usage of GPU resources configured for the target container to use; and
control a resource management module running in the kernel state to configure an operation permission of the process to the target graphics memory buffer area based on the limited usage.

12. The electronic apparatus according to claim 11, wherein the processor is further configured to execute the computer program to:
control the resource management module to obtain an actual usage of GPU resources currently used by the target container; and
when configuring the operation permission, control the resource management module to configure the operation permission based on the actual usage and the limited usage, the operation permission including allowing write operations or not allowing write operations.

13. The electronic apparatus according to claim 12, wherein the processor is further configured to execute the computer program to:
in response to the operation permission being not allowing write operations, control the resource management module to control the process to enter a dormant state responding to the resource management module detecting that the process initiates a write request to the target graphics memory buffer, the write request being used to request to write a GPU resource usage request.

13. The electronic apparatus according to claim 13, wherein the processor is further configured to execute the computer program to, when controlling the process to enter the dormant state responding to the resource management module detecting that the process initiates the write request:
responding to a signal management module in the target container detects an operation-unauthorized instruction sent by the operating system kernel, write a system call instruction into a target device file, the operation-unauthorized instruction indicating that the process initiates the write request to the target graphics memory buffer area while the operation permission is not allowing write operations, and the target device file being used for information exchange between a user state and kernel state; and
control the resource management module to control the process to enter the dormant state in response to detecting that the system call instruction is written into the target device file.

14. The electronic apparatus according to claim 12, wherein:
wherein the actual usage is a first actual usage; and
the processor is further configured to execute the computer program to
in response to the operation permission being not allowing write operations, control the resource management module to obtain a second actual usage of the GPU resources currently used by the target container; and
in response to the second actual usage being less than the limited usage, control the resource management module to configure the operation permission to allowing write operations.

15. The electronic apparatus according to claim 15, wherein the processor is further configured to execute the computer program to:
in response to the second actual usage being less than the limited usage, control the resource management module to wake up the process in a dormant state.

16. The electronic apparatus according to claim 11, wherein the processor is further configured to execute the computer program to:
control the interception module to construct a pseudo device file with a same name as a device file of the kernel driver in the operating system; and
when controlling the interception module to intercept the system call request, control the interception module to obtain the system call request from the pseudo device file.

17. The electronic apparatus according to claim 11, wherein the processor is further configured to execute the computer program to, after determining the process ID and the address information:
control the interception module to forward the system call request to the kernel driver.

18. The electronic apparatus according to claim 11, wherein the processor is further configured to execute the computer program to:
in response to detecting that the target container is started, control the configuration management module to create a configuration file in a virtual file system in the kernel state and t map a file path of the configuration file to a file path corresponding to a file for storing resource configuration information in the target container;
control the configuration management module to obtain the limited usage of the GPU resources that are able to be used by the target container configured in the configuration file; and
control the configuration management module to store a corresponding relationship between the limited usage and the target container.
